(19) United States
(12) Patent Application Publication
(10) Pub. No.: US 2020/0175959 A1
(43) Pub. Date: Jun. 4, 2020

(54) APPARATUS, SYSTEM, METHOD AND COMPUTER PROGRAM

(71) Applicant: Sony Corporation, Tokyo (JP)

(72) Inventors: Fabien CARDINAUX, Stuttgart (DE); Andreas SCHWAGER, Stuttgart (DE); Thomas KEMP, Stuttgart (DE); Stefan UHLICH, Stuttgart (DE); Marc FERRAS FONT, Stuttgart (DE); Franck GIRON, Stuttgart (DE); Patrick PUTZOLU, Stuttgart (DE)

(73) Assignee: Sony Corporation, Tokyo (JP)

(21) Appl. No.: 16/623,401

(22) PCT Filed: Jul. 11, 2018
(86) PCT No.: PCT/EP2018/068859

§ 371 Date: Dec. 17, 2019

(30) Foreign Application Priority Data
Jul. 13, 2017 (EP) 17181197.9

(51) Int. Cl. G10K 15/02; H04R 1/02; H04S 7/00

(52) U.S. Cl. CPC G10K 15/02; H04R 2499/13; H04S 7/30; H04R 1/025

(57) ABSTRACT

An apparatus comprising circuitry configured to generate artificial sound for an electric vehicle, the artificial sound being configured for being easily cancellable, reducible and/or modifiable.

### TECHNICAL FIELD

The present disclosure generally pertains to the field of active noise cancelation.

### TECHNICAL BACKGROUND

Electric vehicles produce a low level of noise. In general, it is very favorable that vehicles emit low noise. However, in some situations, vehicle noise may be beneficial, e.g. for pedestrians, cyclists or other vehicles. In the USA, from 1st Sept. 2019 on, it will be required for all hybrid and electric cars to make audible sound when travelling at speeds up to 30 km/hour. While such vehicle sound is necessary in some situations (e.g. close to a pedestrian crossing), it can also be an annoyance in some other situation.

### SUMMARY

According to a first aspect, the disclosure provides an apparatus comprising circuitry configured to generate artificial sound for an electric vehicle, the artificial sound being configured for being easily cancellable, reducible and/or modifiable.

According to a further aspect, the disclosure provides a system comprising circuitry configured to generate a 3D sound field that is configured to cancel, reduce and/or modify artificial sound of an electric vehicle, the artificial sound being configured for being easily cancellable, reducible and/or modifiable

According to a further aspect, the disclosure provides a method comprising generating artificial sound for an electric vehicle, the artificial sound being configured for being easily cancellable, reducible and/or modifiable.

According to a further aspect, the disclosure provides a method comprising generating a 3D sound field that is configured to cancel, reduce and/or modify artificial sound of an electric vehicle, the artificial sound being configured for being easily cancellable, reducible and/or modifiable.

According to a further aspect, the disclosure provides a computer program comprising instructions which, when executed on a processor, cause the processor to generate artificial sound for an electric vehicle, the artificial sound being configured for being easily cancellable, reducible and/or modifiable.

According to a further aspect the disclosure provides a computer program comprising instructions which, when executed on a processor, cause the processor to generate a 3D sound field that is configured to cancel, reduce and/or modify artificial sound of an electric vehicle, the artificial sound being configured for being easily cancellable, reducible and/or modifiable.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically describes the general principle of noise-cancelation in a situation where a noise-cancelation speaker is co-located with a sound source to be attenuated;

FIG. 2 schematically describes exemplary components of an artificial sound generation system;

FIG. 3 schematically describes an embodiment of an active noise control system for a public space;

FIG. 4 schematically describes an embodiment of vehicle to noise control system communication using artificial sound;

FIG. 5 schematically describes components of an active noise control system;

FIG. 6 provides a schematic diagram of a system applying digitalized Monopole Synthesis algorithm;

FIG. 7 is a block diagram depicting an example of schematic configuration of a vehicle control system; and

FIG. 8 is a diagram of assistance in explaining an example of installation positions of an outside-vehicle information detecting section and an imaging section.

### DETAILED DESCRIPTION OF EMBODIMENTS

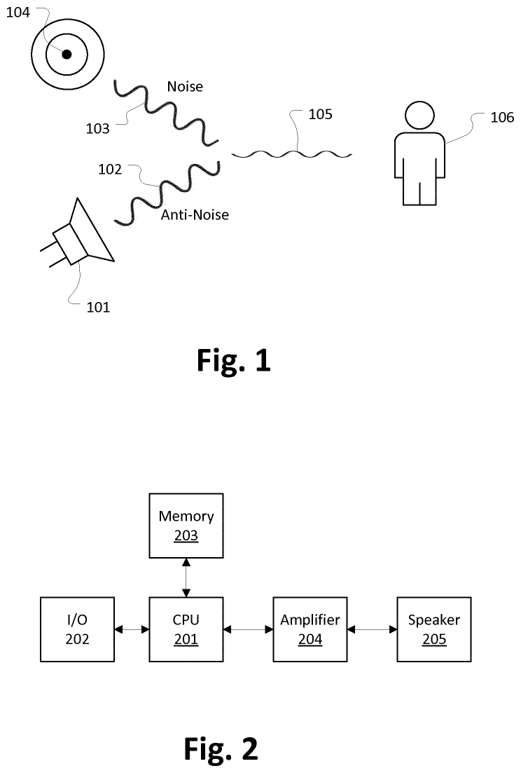

Before a detailed description of the embodiments under reference of FIG. 1 is given, general explanations are made.

In the embodiments described below in more detail, an apparatus is disclosed comprising circuitry configured to generate artificial sound for an electric vehicle, the artificial sound being configured for being easily cancellable, reducible and/or modifiable.

The apparatus may, for example, be an artificial sound generation device.

Artificial sound may, for example, be sound that emulates or replaces vehicle noise that is beneficial e.g. for pedestrians, cyclists or other vehicles to become aware of an approaching vehicle. Artificial sound may, for example, be sound that is generated by algorithms, adaptive algorithms, synthesis, or the like.

For example, the artificial noise generated by the circuitry may be cancellable, reducible and/or modifiable by an active noise control system, for example, an active noise control system as described below in more detail. An active noise control system may be configured to cancel, reduce and/or modify environmental sound, in particular artificial sound that is generated and emitted by an artificial sound generation device.

The active noise control system may, for example, be located outside of a vehicle, e.g. at a restaurant or at a cafe that is close to a street with traffic.

Circuitry may include a processor, a memory (RAM, ROM, or the like), a storage, input means (I/O interfaces, etc.), output means (I/O interfaces), loudspeakers, etc., a (wireless) interface, etc., as it is generally known for electronic devices (computers, automotive controllers, etc.). Moreover, it may include sensors for sensing environmental parameters (image sensor, camera sensor, video sensor, etc.) and/or automotive sensors.

The circuitry may, for example, be embedded in a vehicle, in particular in an electric or hybrid vehicle.

The circuitry may be configured to output the artificial sound by means of a speaker or speaker array arranged at (e.g. in/on) a vehicle.

The circuitry may also comprise amplifiers or the like for generating the artificial sound.

The circuitry may be configured to generate artificial sound in an adjustable manner. For example, the circuitry may be configured to adjust the generation of artificial sound to environmental information.

The environmental information may, for example, be obtained by automotive sensors of a vehicle. For example, the circuitry may be configured to increase the loudness of the artificial sound so that the sound is easily audible next to a pedestrian, and/or wherein the circuitry is configured decrease the loudness of the artificial sound in circumstances when the artificial sound can become an unnecessary annoyance.

The artificial sound may be a periodic and/or stationary sound.

The artificial sound may be a standardized sound.

The artificial sound may be additively synthesized to make the sound easy to cancel. For example, the artificial sound may comprise an oscillating trigger as basic low frequency and other wave signals of low/mid frequencies that are referring to the phase of this base frequency.

A measured sound pressure level of the oscillating trigger may be used to determine the air travel loss of higher frequencies.

The circuitry may be configured to emit an artificial sound that can be differentiated from artificial sound of other vehicles or vehicle types.

The artificial sound may encode information. For example, the artificial sound may encode information comprising information about the driving situation of a vehicle.

The circuitry may be configured to determine information concerning the situation of a vehicle and to adjust the artificial sound emitted by the vehicle for the situation of the vehicle based on the determined information.

The circuitry may be configured to emit artificial sound that is immune against multipath transmissions.

Also, the circuitry may be configured to emit artificial sound that is immune against Doppler effects.

In the embodiments described below in more detail it is also disclosed a system comprising circuitry configured to generate a 3D sound field that is configured to cancel, reduce and/or modify artificial sound of an electric vehicle, the artificial sound being configured for being easily cancellable, reducible and/or modifiable. The system may for example be an active noise control system.

The artificial sound that is configured for being easily canceled, reduced and/or modified with the active noise control system may, for example, be produced by an artificial sound generation device located (e.g. in/on) a vehicle.

The circuitry may be configured to generate the 3D sound field based on monopole synthesis, wavefield synthesis, or the like.

Also, the circuitry may be configured to actively reduce noise at a public space, e.g. at a restaurant or a cafe.

The circuitry may be configured to control a speaker array. The speaker array may, for example, be arranged at or around a public space, e.g. at a restaurant or a cafe.

The circuitry may be configured to receive feedback information from microphones. Also, such microphones may, for example, be arranged at or around a public space, e.g. at a restaurant or a cafe.

The circuitry may be configured to decode information from an artificial sound produced by a vehicle. The circuitry may be configured to use the decoded information in canceling, reducing or modifying environmental sounds.

The decoded information may comprise information about the driving situation of a vehicle such as vehicle speed, GPS location and the like, and the decoded information may comprise information about the brand, model and/or identity of a vehicle.

In the embodiments described below in more detail, also a method is disclosed, the method comprising generating artificial sound for an electric vehicle, the artificial sound being configured for being easily cancellable, reducible and/or modifiable. The method may comprise any of the processes described above and in the detailed description of embodiments that follows below.

In the embodiments described below in more detail, also a method is disclosed, the method comprising generating a 3D sound field that is configured to cancel, reduce and/or modify artificial sound of an electric vehicle, the artificial sound being configured for being easily cancellable, reducible and/or modifiable. The method may comprise any of the processes described above and in the detailed description of embodiments that follows below.

In the embodiments described below in more detail, also a computer program is disclosed, the computer program comprising instructions which, when executed on a processor, cause the processor to generate artificial sound for an electric vehicle, the artificial sound being configured for being easily cancellable, reducible and/or modifiable.

In the embodiments described below in more detail, also a computer program is disclosed, the computer program comprising instructions which, when executed on a processor, cause the processor to generate a 3D sound field that is configured to cancel, reduce and/or modify artificial sound of an electric vehicle, the artificial sound being configured for being easily cancellable, reducible and/or modifiable.

In some embodiments, also a non-transitory computer-readable recording medium is provided that stores therein a computer program product, which, when executed by a processor, such as the processor described above, causes the methods described herein to be performed.

Principle of Noise-Cancelation

FIG. 1 schematically describes the general principle of noise-cancelation in a situation where a noise-cancelation speaker 101 is co-located with a sound source 104 to be attenuated. The noise-cancelation speaker 101 emits as an anti-sound a sound wave 102 with the same amplitude but with inverted phase (also known as antiphase) to the original sound 103 emitted by sound source 104. In a process called interference the waves combine to form a residual wave 105, and effectively cancel each other out by destructive interference. The residual wave 105 is perceived by a listener 106 as a residual sound signal. In the case where a noise-cancelation speaker is co-located with the sound source to be attenuated, the noise-cancelation speaker 101 should preferably have the same audio power level as the source 104 to be attenuated.

Artificial Sound Generation Device

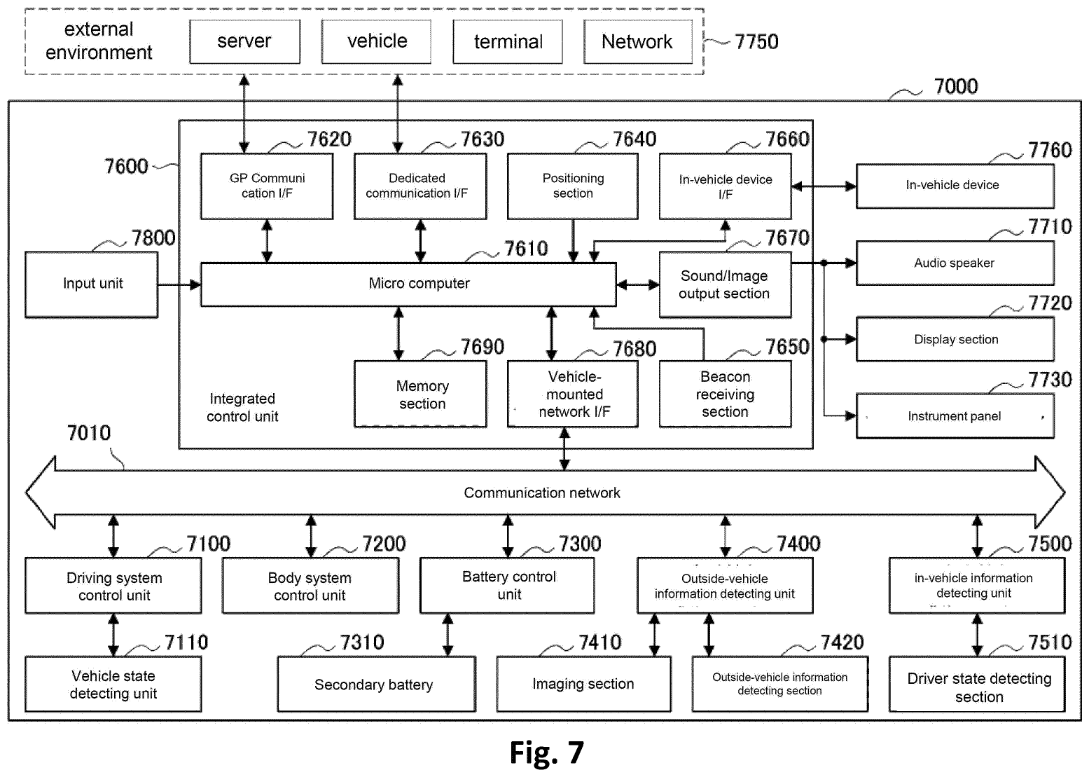

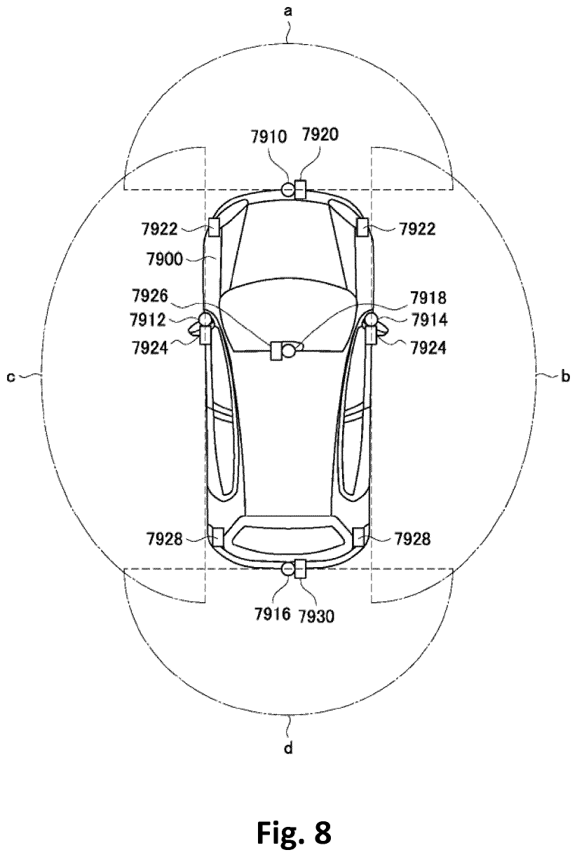

FIG. 2 schematically describes an artificial sound generation device. The artificial sound generation device 200 may for example be embedded in an electric vehicle (as described with regard to FIGS. 7 and 8 below in more detail). The artificial sound generation device produces sound that is configured to be easy cancellable, reducible and/or modifiable. e.g. with an active noise control system located outside the vehicle. The artificial sound generation in the artificial sound generation device 200 is generally achieved through the use of a processor 201 which comprises circuitry for digital signal processing. The processor 201 may be part of an integrated control unit (e.g. integrated control unit 7600 in FIG. 7). Algorithms stored in a memory 203 (e.g. memory section 7690 in FIG. 7) and carried out by processor 201 are designed to generate an artificial sound signal that is configure for being easily cancellable, reducible and/or modifiable from an active noise control system from outside the vehicle. This generated sound signal is then amplified in an amplifier 204 (which may be part of a Sound/Image output section such as 7690 in FIG. 7) and a speaker or speaker array 205 (schematically depicted as audio speaker 7710 in FIG. 7) creates a sound wave corresponding to the generated sound signal. The artificial sound emitted by device 200 further comprises an I/O interface (e.g. general-purpose communication I/F 7620, dedicated communication I/F 7630, in-vehicle device I/F 7660, or vehicle mounted network I/F 7680 of FIG. 7) which connects the device to other devices in an electric car, such as sensors, camera, or the like.

The algorithms implemented by processor 201 may be configured to provide adjustable artificial sound. For example, the artificial sound generated by the artificial sound generation device 200 may depend on automotive sensors that are applied in the framework of an electric and/or self-driving car. The artificial sound emitted by the device 200 when applied in electric or hybrid vehicles can open new opportunities to modify the sound according to circumstances. The artificial sound generation device 200 may, for example, adapt the generated artificial sound to its environment as obtained by an analysis of automotive sensors. Information concerning the environment of the vehicle may, for example, be obtained by an outside-vehicle information detecting unit (see e.g. 7400, 7410 and 7420 in FIG. 7). For example, next to a pedestrian who is passed or approached by the vehicle, the device may increase the loudness of the artificial sound so that the sound is easily audible. In some other circumstances, when the sound can become an unnecessary annoyance (e.g. residential area, high traffic area, etc.), the algorithms may decrease the loudness of the artificial sound.

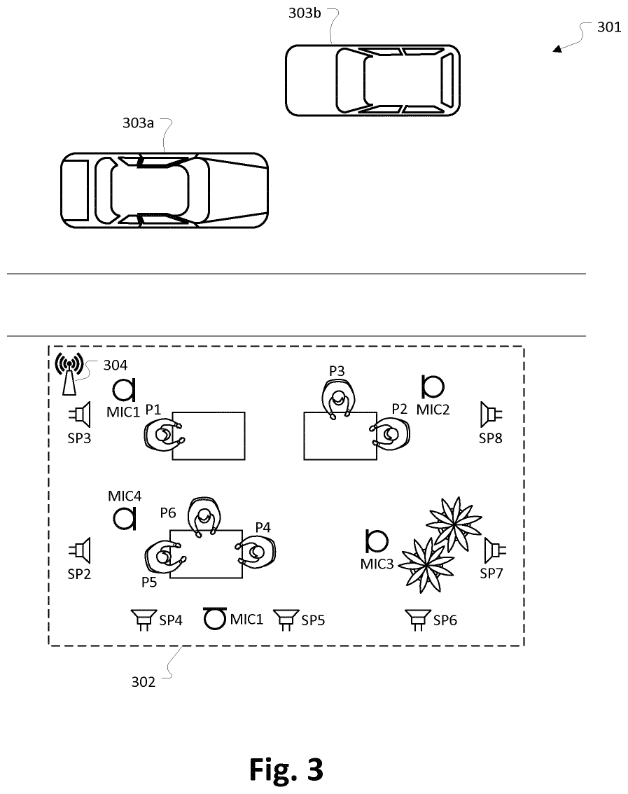

With an artificial sound generation device as described above, a vehicle that implements the device emits an artificial sound (e.g. a constant sound) and at each location the sound can be modified according to the circumstances and needs at this specific location. For example, as described below in more detail with regard to the embodiment of FIG. 3, a restaurant or cafe owner can decide to set up a system to cancel automotive sounds on the terrace of his restaurant. This becomes feasible because the sound emitted by the vehicle is especially designed to be easily canceled.

Generation of Artificial Sound that can be Easily Canceled, Attenuated or Altered

According to an embodiment, the artificial sound generation device generates artificial sound which can be easily canceled, attenuated or altered.

For example, a periodic and stationary sound is a good option in terms of simplicity, performance of active noise control and efficient radiation of acoustic power.

The artificial sound generation device may be arranged to emit a fixed (constant) sound.

For example, according to an embodiment, the emitting sound of the vehicle is additively synthesized with the intention to make the complete sound easy to cancel. Since low frequencies are easy to phase-cancel, the concept of the sound design of this embodiment is referring to a basic low frequency (e.g. 100 Hz). Other low/mid frequencies are referring to the phase of this base frequency. Due to the static relation to the base frequency, the complete additively synthesized emitting sound can be phase-canceled with optimized results.

For example, an oscillating trigger (short rectangular waveform) is generated at 100 Hz. This trigger is then used as a reference for the phase position of added sine wave signals. The added sine waves have a determined and easy to calculate phase relation to the triggered base frequency (e.g. 100 Hz multiplied by 1 and 1.5, and 2 and 2.5, and 3 and 3.5, . . . ). Due to their fixed phase relation to the trigger, an external phase cancelation device (Active vehicle noise cancelation) can react on the trigger information by deriving the correct anti-phase signals for the added frequencies.

In addition the measured Sound Pressure Level (SPL) of the trigger may contribute to determine the air travel loss of higher frequencies.

For example, the trigger signal is detected by the microphone that is used by the active sound cancellation unit (schematically depicted as 101 in FIG. 1). The sound cancellation unit may measure both the phase of the trigger signal and the loudness (the energy) of the received trigger signal. Since the frequency of the emitted noise ( 103 in FIG. 1) is a priori known, the only unknown parameters that are required to cancel out the sound are the phase and the loudness for the Anti-Noise (102 in FIG. 1). The loudness can be determined from the measured loudness of the trigger signal, using the known relationship between the loudness of the trigger signal and the noise 103, and optionally also using the well-known frequency dependent attenuation factor of sound transmission through air.

The phase can be extracted from the known relationship of the constituent frequencies in noise (103 in FIG. 1) relative to the trigger signal, and a fixed reference point that must be encoded in the trigger signal (e.g. a louder “spike” in the trigger, or the end of the trigger signal).

The sound emitted by the vehicles could be standardized for easier active noise control from outside devices (such as described with regard to FIG. 3 below) or vehicle specific, so that the driver and/or the vehicle control system can cancel/reduce the noise of its own vehicle but can still hear the noise of other vehicles.

For example, each vehicle may emit an artificial sound that is characteristic to the vehicle or vehicle type and can be differentiated from the sound of other vehicles/vehicle types with some good likelihood. For example, a first vehicle may be arranged to apply a trigger frequency of 80 Hz, a second vehicle may be arranged to apply a trigger frequency of 82 Hz, a third vehicle may be arranged to apply a trigger frequency of 84 Hz, and so on. Alternatively, a first vehicle type may be arranged to apply a trigger frequency of 80 Hz, a second vehicle type may be arranged to apply a trigger frequency of 82 Hz, a third vehicle type may be arranged to apply a trigger frequency of 84 Hz, and so on.

According to other embodiments, the trigger signal can carry a vehicle information encoded (e.g. signature information) in the waveform as well (see section “Communication using artificial sound” below). Such information may help an active noise control system in its task of reducing noise.

According to an embodiment, the artificial sound generation device is arranged to adaptively alter the artificial sound in dependency of the environment. For example, the artificial sound generation device may be arranged so that the vehicle emits sound that is easier to cancel in a specific environment (e.g., city, motorway, etc.). The provided information (any information concerning the situation of the vehicle, e.g. GPS coordinates, map data, vehicle speed, images of a camera, etc.) may then be used to calculate the sound field emitted by the vehicle for the surrounding area where vehicle noise needs to be emitted. For example, the emitted sound may be adjusted directly according to the vehicle's current situation: in a city, on the motorway, at night, during daytime, close to a pedestrian crossing. In addition, the sound may be adjusted according to the speed of the vehicle. For example, GPS data may for example be used to anticipate the surrounding area, especially visual blocking buildings, to emit sound in these directions. Thus, a safe sound emittance is provided and sound is only emitted where and when it is required.

According to other embodiments, the artificial sound generation device is arranged to emit sound that is immune against multipath transmissions. This may be helpful in the case where a vehicle operates e.g. in an urban “canyon” where the signal is reflected multiple times from buildings left and right of the road. Technical concepts for generating sound that is immune against multipath transmissions are known to the skilled person. For example, in OFDM communication there is the concept of “Guard Intervals” that makes the communication immune against multipath transmissions. Still further, if the communication channel is known to the transmitter a predistortion of the signals may be implemented to let the signals arrive clear and in good quality at the receiver. Still further, video broadcast systems transmit a known reference impulse that allows the receiver to estimate the channel and eliminate multipath reflections.

According to other embodiments, the artificial sound generation device is arranged to emit sound that is immune against Doppler effects. This may be helpful in situations in which a vehicle passes a place where the cancelation happens, and Doppler effects cause a frequency change in the signal. Accordingly, these embodiments disclose a canceling system that performs well despite of such frequency changes. Technical concepts to emit sound that is immune against Doppler effects are e.g. provided by AFC (“automatic frequency control”) that is also implemented in radio receivers.

Noise Canceling Applied at a Public Space

According to some embodiments, noise canceling/reduction/alteration is applied at different locations. E.g. a cafe with a terrace next to a street might install a 3D sound field, where the electronic vehicles' noises are eliminated. At different places, active noise control devices can be set up to emit 3D sound fields which could cancel, reduce or modify the emitted sound according to the specific needs of the location. As each location may adopt its own 3D sound field, this may offer flexibility for every location to adjust the perceived sound independently.

FIG. 3 schematically describes an embodiment of an active noise control system for a public space. A speaker array comprising eight speakers SP1 to SP8 are arranged around a public space 302, here a terrace of a café, where several people P1 to P6 are located at tables. Four feedback microphones MIC1 to MIC4 are provided to capture the sound in the public space 302. The public space 302 is close to a street 301 where two electric vehicles 303a and 303b are producing a noise signal. The speakers SP1 to SP8 are located at the location where an attenuation of the vehicles' noise signal is wanted. The active noise control system is effective for all persons P1 to P6 in the public space 302. Here, as the noise cancelation happens at a location that is far away from the noise source, adaptive algorithms are provided that take into account that three-dimensional wave fronts of the unwanted sound and the cancelation signal may match and create alternating zones of constructive and destructive interference, reducing noise in some spots while doubling noise in others. The loudspeakers SP1 to SP8 are driven by a processor (not shown in FIG. 3) such as described with regard to the embodiment of FIG. 4, described below in more detail. The processor of the active noise control system is connected to a wireless radio transceiver 304 which is provided at public space 302. Also the electric vehicles 303a and 303b are provided with such wireless radio transceivers (not shown in FIG. 3). The radio transceiver 304 thus enables a wireless communication of the active noise control system with controllers in the electric vehicles 303a and 303b.

Communication Using Artifical Sound

Additionally, relevant information about the driving situation can be embedded in the artificial sound as well.

FIG. 4 shows an embodiment of vehicle to active noise control system communication using artificial sound. A loudspeaker 401, located, e.g., at (e.g. in/on) an electric vehicle, emits artificial sound 402 produced by an artificial sound generation device such as described with regard to FIG. 2. The artificial sound 402 embeds information 404 about the driving situation. For example, bursts of sine waves and more complex types of modulation may be used to convey additional information, such as the speed of the vehicle or the detected distance to obstacles or to pedestrians. A microphone 403, located, e.g., at a public space that is provided with an active noise control system (such as described with regard to FIG. 3 above) receives the artificial sound 402 and decodes the embedded information 404. An active noise control system may use this decoded information as input to adaptive algorithms that generate a 3D sound field for noise canceling/reduction/alteration.

An example of information embedded in the artificial sound may be as follows (in an abstract notation):

```
<data>
  <vehicle>
    <speed>20 mph</speed>
    <gps>35.61745N, 139.72832E</gps>
  </vehicle>
  <sound>
    <frequency>40Hz</frequency>
  </sound>
  ...
</data>
```

Here the information comprised within the <vehicle>-Tags denotes information about the driving situation such as vehicle speed and vehicle GPS location, and the information comprised within the <sound>-Tags denotes information about the artificial sound that carries this information, such as the frequency of the artificial sound, and the like. This information may help the active noise control system in the adaptive sound cancelation process.

Regarding communication of an active noise control system with vehicles, the brand/model/identity of the vehicle could be transmitted using Code division multiple access (CDMA) codes that are perceived as broadband noise to a human listener. This allows an active noise control system to cancel the sound of some vehicle brands only. E.g. if there is a motorcycle cafe which has a focus on a specific motorcycle model, the sound of any vehicles, but not this specific motorcycle model, might be canceled and the visitors of the cafe may enjoy only the sound of motorcycles that correspond to the motorcycle model the cafe is dedicated to.

Active Noise Control System

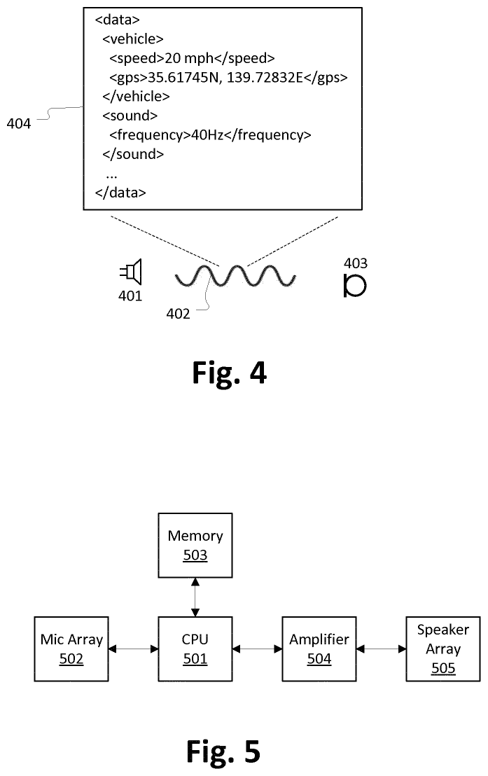

FIG. 5 schematically describes components of an active noise control system. The active noise control is generally achieved through the use of a processor 501 which comprises circuitry for digital signal processing. A microphone array 502 (such as MIC1 to MIC4 in FIG. 3) is arranged to obtain the background noise. Adaptive algorithms stored in a memory 503 and carried out by processor 501 are designed to analyze the waveform of the background noise, and then, based on the adaptive algorithms, generate a signal that will either phase shift or invert the polarity of the original signal. This inverted signal (in antiphase) is then amplified in an amplifier 504 and a speaker or speaker array 505 (such as SP1 to SP8 in FIG. 3) creates a 3D sound wave field that is directly proportional to the amplitude of the unwanted waveform, creating destructive interference. This effectively reduces the volume of the perceivable noise in the area of influence (public space 302 in FIG. 3) of the active noise control system. Algorithms that may be applied in the active noise control system are conceptually similar to Wavefield synthesis algorithms, and they may in particular correspond to the concept of monopole synthesis. Embodiments of algorithms that may be applied in the active noise control system are described below in more detail.

System for Digitalized Monopole Synthesis

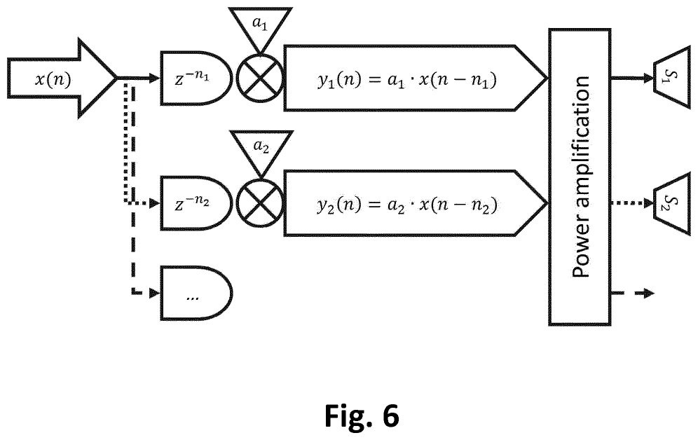

FIG. 6 provides an embodiment of a system which implements a method that is based on a digitalized Monopole Synthesis algorithm in the case of integer delays.

The theoretical background of this system is described in more detail in patent application U.S. 2016/0037282 A1 which is herewith incorporated by reference.

The technique which is implemented in the embodiments of U.S. 2016/0037282 A1 is conceptually similar to the Wavefield synthesis, which uses a restricted number of acoustic enclosures to generate a defined sound field. The fundamental basis of the generation principle of the embodiments is, however, specific, since the synthesis does not try to model the sound field exactly but is based on a least square approach.

A target sound field is modelled as at least one target monopole placed at a defined target position. In one embodiment, the target sound field is modelled as one single target monopole. In other embodiments, the target sound field is modelled as multiple target monopoles placed at respective defined target positions. For example, each target monopole may represent a noise cancelation source comprised in a set of multiple noise cancelation sources positioned at a specific location within a space. The position of a target monopole may be moving. For example, a target monopole may adapt to the movement of a noise source to be attenuated. If multiple target monopoles are used to represent a target sound field, then the methods of synthesizing the sound of a target monopole based on a set of defined synthesis monopoles as described below may be applied for each target monopole independently, and the contributions of the synthesis monopoles obtained for each target monopole may be summed to reconstruct the target sound field.

A source signal x(n) is fed to delay units labelled by z⁻ⁿ^{ₚ} and to amplification units aₚ, where p=1, . . . , N is the index of the respective synthesis monopole used for synthesizing the target monopole signal. The delay and amplification units according to this embodiment may apply equation (117) to compute the resulting signals yₚ(n)=sₚ(n) which are used to synthesize the target monopole signal. The resulting signals sₚ(n) are power amplified and fed to loudspeaker Sₚ.

In this embodiment, the synthesis is thus performed in the form of delayed and amplified components of the source signal x.

According to this embodiment, the delay nₚ for a synthesis monopole indexed p is corresponding to the propagation time of sound for the Euclidean distance

$$r = {R}_{p 0} = \vert {r}_{p} - {r}_{o} \vert$$

between the target monopole rₒ and the generator rₚ.

Further, according to this embodiment, the amplification factor

$${a}_{p} = \frac{ρ c}{{R}_{p 0}}$$

is inversely proportional to the distance r=Rₚ₀.

In alternative embodiments of the system, the modified amplification factor according to equation (118) of U.S. 2016/0037282 A1 can be used.

In yet further alternative embodiments of the system, a mapping factor as described with regard to FIG. 9 of U.S. 2016/0037282 A1 can be used to modify the amplification.

### EXAMPLES OF APPLICATION

The technology according to an embodiment of the present disclosure, in particular an artificial sound generation device as described above, is applicable to various products. For example, the technology according to an embodiment of the present disclosure may be implemented as a device included in a mobile body that is any of kinds of automobiles, electric vehicles, hybrid electric vehicles, motorcycles, bicycles, personal mobility vehicles, airplanes, drones, ships, robots, construction machinery, agricultural machinery (e.g., tractors), and the like.

FIG. 7 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 7, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like, within and without the vehicle by wire communication or radio communication. A functional configuration of the integrated control unit 7600 illustrated in FIG. 7 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal lamp, a fog lamp, or the like. In this case, radio waves transmitted from a mobile device as an alternative to a key, or signals of various kinds of switches, can be input to the body system control unit 7200. The body system control unit 7200 receives these input radio waves or signals, and controls a door lock device, the power window device, the lamps, or the like, of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like, from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like, on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

FIG. 8 depicts an example of installation positions of the imaging section 7410 and the outside-vehicle information detecting section 7420. Imaging sections 7910, 7912, 7914, 7916, and 7918 are, for example, disposed at at least one of the following positions: on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 8 depicts an example of photographing ranges of the respective imaging sections 7910, 7912, 7914, and 7916. An imaging range a represents the imaging range of the imaging section 7910 provided to the front nose. Imaging ranges b and c, respectively, represent the imaging ranges of the imaging sections 7912 and 7914 provided to the sideview mirrors. An imaging range d represents the imaging range of the imaging section 7916 provided to the rear bumper or the back door. A bird's-eye view image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 7, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like, on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye view image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing, or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like, that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit, or the like, that generates an input signal on the basis of information input by an occupant, or the like, using the above-described input section 7800, and which outputs the generated input signal to the integrated control unit 7600. An occupant, or the like, inputs various kinds of data or gives an instruction for processing operations to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD), or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a vehicle and a road (Vehicle to Infrastructure), communication between a vehicle and a home (Vehicle to Home), and communication between a vehicle and a pedestrian (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road, or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish a wireless connection using a wireless communication protocol such as wireless LAN, Bluetooth (registered trademark), near field communication (NFC), or wireless universal serial bus (WUSB). In addition, the in-vehicle device I/F 7660 may establish a wired connection by universal serial bus (USB), high-definition multimedia interface (HDMI (registered trademark)), mobile high-definition link (MHL), or the like, via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals, or the like, in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automatic driving, which makes the vehicle to travel autonomously without depending on the operation of the driver, or the like, by controlling the driving force generating device, the steering mechanism, the braking device, or the like, on the basis of the obtained information about the surroundings of the vehicle.

The microcomputer 7610 of the integrated control unit 7600 may in particular control the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may implement adaptive algorithms for generating artificial sound as described in the embodiment above Likewise, the microcomputer 7610 may control vehicle to active noise control device communication as described in the embodiments above.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. This information may be used as input for an adaptive sound generation as described in the embodiments above. In addition, the microcomputer 7610 may predict danger such as collision of the vehicle, approaching of a pedestrian, or the like, an entry to a closed road, or the like, on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or audibly notifying information to an occupant of the vehicle or the outside of the vehicle. In particular, the sound/image output section 7670 may be used to generate artificial sound as described in the embodiment above. In the example of FIG. 7, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant, or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data, or the like, into an analog signal, and audibly outputs the analog signal.

Incidentally, at least two control units connected to each other via the communication network 7010 in the example depicted in FIG. 7 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Incidentally, a computer program for realizing the functions of the information processing device 100 according to the present embodiment described with reference to FIG. 7 can be implemented in one of the control units, or the like. In addition, a computer readable recording medium storing such a computer program can also be provided. The recording medium is, for example, a magnetic disk, an optical disk, a magneto-optical disk, a flash memory, or the like. In addition, the above-described computer program may be distributed via a network, for example, without the recording medium being used.

It should be recognized that the embodiments describe methods with an exemplary ordering of method steps. The specific ordering of method steps is however given for illustrative purposes only and should not be construed as binding.

It should also be noted that the division of the control or circuitry of FIGS. 2, 5, 6, and 7 into units is only made for illustration purposes and that the present disclosure is not limited to any specific division of functions in specific units. For instance, at least parts of the circuitry could be implemented by a respective programmed processor, field programmable gate array (FPGA), dedicated circuits, and the like.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below:

(1) An apparatus comprising circuitry configured to generate artificial sound for an electric vehicle, the artificial sound being configured for being easily cancellable, reducible and/or modifiable

(2) The apparatus of (1), wherein the circuitry is embedded in a vehicle.

(3) The apparatus of anyone of (1) to (2), wherein the circuitry is configured to generate artificial sound in an adjustable manner.

(4) The apparatus of anyone of (1) to (3), wherein the circuitry is configured to adjust the generation of artificial sound to environmental information.

(5) The apparatus of anyone of (1) to (4), wherein the environmental information is obtained by automotive sensors of a vehicle.

(6) The apparatus of anyone of (1) to (5), wherein the artificial sound is a periodic and/or stationary sound.

(7) The apparatus of anyone of (1) to (6), wherein the artificial sound is a standardized sound.

(8) The apparatus of anyone of (1) to (7), wherein the artificial sound is additively synthesized to make the sound easy to cancel.

(9) The apparatus of anyone of (1) to (8), wherein the artificial sound comprises an oscillating trigger as basic low frequency and other wave signals of low/mid frequencies that are referring to the phase of this base frequency.

(10) The apparatus of (9), wherein a measured sound pressure level of the oscillating trigger is used to determine the air travel loss of higher frequencies.

(11) The apparatus of anyone of (1) to (10), wherein the circuitry is configured to emit an artificial sound that can be differentiated from artificial sound of other vehicles or vehicle types.

(12) The apparatus of anyone of (1) to (11), wherein the artificial sound encodes information.

(13) The apparatus of anyone of (1) to (12), wherein the artificial sound encodes information comprising information about the driving situation of a vehicle.

(14) The apparatus of anyone of (1) to (13), wherein the circuitry is configured to determine information concerning the situation of a vehicle and to adjust the artificial sound emitted by the vehicle for the situation of the vehicle based on the determined information.

(15) The apparatus of anyone of (1) to (14), wherein the circuitry is configured to emit artificial sound that is immune against multipath transmissions.

(16) The apparatus of anyone of (1) to (15), wherein the circuitry is configured to emit artificial sound that is immune against Doppler effects.

(17) A system comprising circuitry configured to generate a 3D sound field that is configured to cancel, reduce and/or modify artificial sound that is configured for being easily cancellable, reducible and/or modifiable.

(18) The system of (17), wherein the circuitry is configured to generate the 3D sound field based on monopole synthesis.

(19) The system of (17) or (18), wherein the circuitry is configured to actively reduce noise at a public space.

(20) The system of anyone of (17) to (19), wherein the circuitry is configured to control a speaker array.

(21) The system of anyone of (17) to (20), wherein the circuitry is configured to receive feedback information from microphones.

(22) The system of anyone of (17) to (21), wherein the circuitry is configured to decode information from an artificial sound produced by a vehicle.

(23) The system of (22), wherein the circuitry is configured to use the decoded information in canceling, reducing or modifying environmental sounds.

(24) The system of (22) or (23), wherein the decoded information comprises information about the driving situation of a vehicle such as vehicle speed, GPS location and the like.

(25) The system of anyone of (22) to (24), wherein the decoded information comprises information about the brand, model and/or identity of a vehicle.

(26) A method comprising generating artificial sound for an electric vehicle, the artificial sound being configured for being easily cancellable, reducible and/or modifiable.

(27) A method comprising generating a 3D sound field that is configured to cancel, reduce and/or modify artificial sound of an electric vehicle, the artificial sound being configured for being easily cancellable, reducible and/or modifiable.

(28) A computer program comprising instructions which, when executed on a processor, cause the processor to generate artificial sound for an electric vehicle, the artificial sound being configured for being easily cancellable, reducible and/or modifiable.

(29) A computer program comprising instructions which, when executed on a processor, cause the processor to generate a 3D sound field that is configured to cancel, reduce and/or modify artificial sound of an electric vehicle, the artificial sound being configured for being easily cancellable, reducible and/or modifiable.

1. An apparatus comprising circuitry configured to generate artificial sound for an electric vehicle, the artificial sound being configured for being easily cancellable, reducible and/or modifiable.

2. The apparatus of claim 1, wherein the circuitry is embedded in an electric vehicle.

3. The apparatus of claim 1, wherein the circuitry is configured to generate artificial sound in an adjustable manner.

4. The apparatus of claim 1, wherein the circuitry is configured to adjust the generation of artificial sound to environmental information.

5. The apparatus of claim 4, wherein the environmental information is obtained by automotive sensors of a vehicle.

6. The apparatus of claim 1, wherein the artificial sound is a periodic and/or stationary sound.

7. The apparatus of claim 1, wherein the artificial sound is additively synthesized to make the sound easy to cancel.

8. The apparatus of claim 1, wherein the artificial sound comprises an oscillating trigger as basic low frequency and other wave signals of low/mid frequencies that are referring to the phase of this base frequency.

9. The apparatus of claim 8, wherein a measured sound pressure level of the oscillating trigger is used to determine the air travel loss of higher frequencies.

10. The apparatus of claim 1, wherein the circuitry is configured to emit an artificial sound that can be differentiated from artificial sound of other vehicles or vehicle types.

11. The apparatus of claim 1, wherein the artificial sound encodes information.

12. The apparatus of claim 1, wherein the artificial sound encodes information comprising information about the driving situation of a vehicle.

13. The apparatus of claim 1, wherein the circuitry is configured to determine information concerning the situation of a vehicle and to adjust the artificial sound emitted by the vehicle for the situation of the vehicle based on the determined information.

14. The apparatus of claim 1, wherein the circuitry is configured to emit artificial sound that is immune against multipath transmissions.

15. The apparatus of claim 1, wherein the circuitry is configured to emit artificial sound that is immune against Doppler effects.

16. A system comprising circuitry configured to generate a 3D sound field that is configured to cancel, reduce or modify artificial sound of an electric vehicle, the artificial sound being configured for being easily cancellable, reducible and/or modifiable.

17. A method comprising generating artificial sound for an electric vehicle, the artificial sound being configured for being easily cancellable, reducible and/or modifiable.

18. A method comprising generating a 3D sound field that is configured to cancel, reduce or modify artificial sound of an electric vehicle, the artificial sound being configured for being easily cancellable, reducible and/or modifiable.

19. A computer program comprising instructions which, when executed on a processor, cause the processor to generate artificial sound for an electric vehicle, the artificial sound being configured for being easily cancellable, reducible and/or modifiable.

20. A computer program comprising instructions which, when executed on a processor, cause the processor to generate a 3D sound field that is configured to cancel, reduce and/or modify artificial sound of an electric vehicle, the artificial sound being configured for being easily cancellable, reducible and/or modifiable.
